(19) United States
(12) Patent Application Publication
(10) Pub. No.: US 2019/0256034 A1
(43) Pub. Date: Aug. 22, 2019

(54) AIR BAG APPARATUS

(71) Applicant: NIHON PLAST CO., LTD., Shizuoka (JP)

(72) Inventors: Chiari SAITO, Shizuoka (JP); Katsuya MURAMATSU, Shizuoka (JP); Masaru MORITAKE, Shizuoka (JP)

(21) Appl. No.: 16/270,696

(22) Filed: Feb. 8, 2019

(30) Foreign Application Priority Data
Feb. 20, 2018 (JP) 2018-027538

(51) Int. Cl. B60R 21/239

(52) U.S. Cl. CPC B60R 21/239; B60R 2021/2395

(57) ABSTRACT

Provided is an air bag apparatus in which it is possible to facilitate control of the internal pressure of an air bag main body at the time of full inflation and deployment of the air bag main body to appropriately secure the exhaust performance at the time of the full inflation and deployment of the air bag main body. Air bag apparatus includes bag-shaped air bag main body having vent hole, and lid body disposed outside air bag main body. Air bag apparatus further includes connecting member which is disposed in the interior of air bag main body and has one end joined to air bag main body, and the other end joined to lid body. Length from one end to the other end of connecting member is set such that clearance is formed between vent hole and lid body when air bag main body is fully inflated and deployed.

### CROSS REFERENCE TO RELATED APPLICATIONS

This application is entitled to the benefit of Japanese Patent Application No. 2018-27538, filed on Feb. 20, 2018, the disclosure of which including the specification, drawings and abstract is incorporated herein by reference in its entirety.

### TECHNICAL FIELD

The present invention relates to an air bag apparatus.

### BACKGROUND ART

In the related art, an air bag apparatus which protects an occupant from an impact when a vehicle such as an automobile collides is known (for example, PTL 1).

The air bag apparatus includes, for example, a bag-shaped air bag main body having a vent hole, and a lid body which is disposed outside the air bag main body. In such an air bag apparatus, the air bag main body and the lid body are connected to each other by a connecting member, and a configuration is made such that when the air bag main body is fully inflated and deployed, the connecting member draws a part of the lid body into the interior of the air bag main body, whereby the vent hole is hermetically sealed by the lid body.

### CITATION LIST

### Patent Literature

### PTL 1

Japanese Patent Application Laid-Open No. 2016-13712

### SUMMARY OF INVENTION

### Technical Problem

In the air bag apparatus as described above, when the air bag main body is fully inflated and deployed, a part of the lid body is drawn into the interior of the air bag main body, so that the vent hole is hermetically sealed by the lid body, and therefore, pressure accumulation performance when the air bag main body is fully inflated and deployed is good. However, since the vent hole is hermetically sealed by the lid body when the air bag main body is fully inflated and deployed, it is difficult to control the internal pressure of the air bag main body when the air bag main body is fully inflated and deployed.

Therefore, the present invention has an object to provide an air bag apparatus in which it is possible to facilitate control of the internal pressure of an air bag main body at the time of full inflation and deployment of the air bag main body to appropriately secure exhaust performance at the time of the full inflation and deployment of the air bag main body.

### Solution to Problem

According to an aspect of the present invention, there is provided an air bag apparatus including: a bag-shaped air bag main body having a vent hole; a lid body which is disposed outside the air bag main body; and a connecting member which is disposed in an interior of the air bag main body and has one end which is joined to the air bag main body, and the other end which is joined to the lid body. A length from one end to the other end of the connecting member is set such that a clearance is formed between the vent hole and the lid body when the air bag main body is fully inflated and deployed.

### Advantageous Effects of Invention

According to the air bag apparatus according to the present invention, it is possible to facilitate control of the internal pressure of the air bag main body at the time of the full inflation and deployment of the air bag main body to appropriately secure the exhaust performance at the time of the full inflation and deployment of the air bag main body.

### BRIEF DESCRIPTION OF DRAWINGS

FIG. 1 is a perspective view showing a fully inflated and deployed state of an air bag apparatus according to an embodiment of the present invention; and

FIG. 2 is a longitudinal sectional view of the air bag apparatus of FIG. 1.

### DESCRIPTION OF EMBODIMENTS

Hereinafter, an embodiment of the present invention will be described in detail with reference to the drawings.

In this embodiment, an air bag apparatus for a driver's seat, which is provided in a steering wheel of a vehicle, is exemplified.

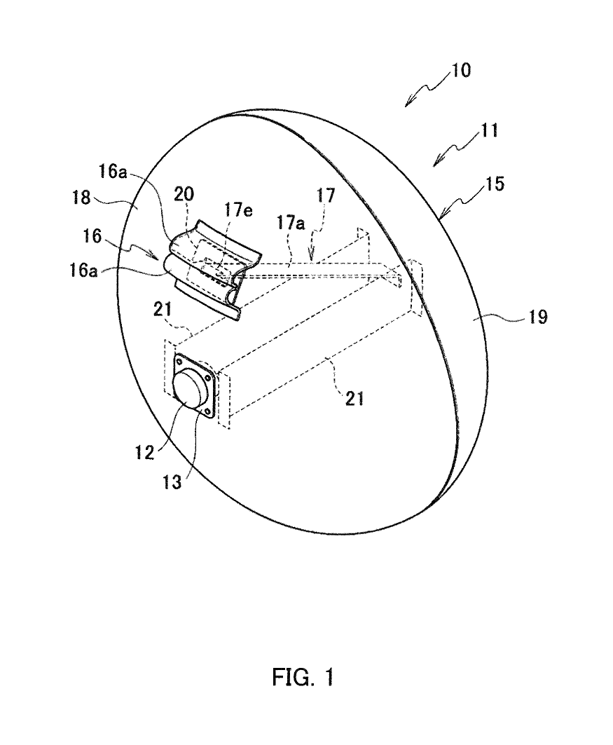

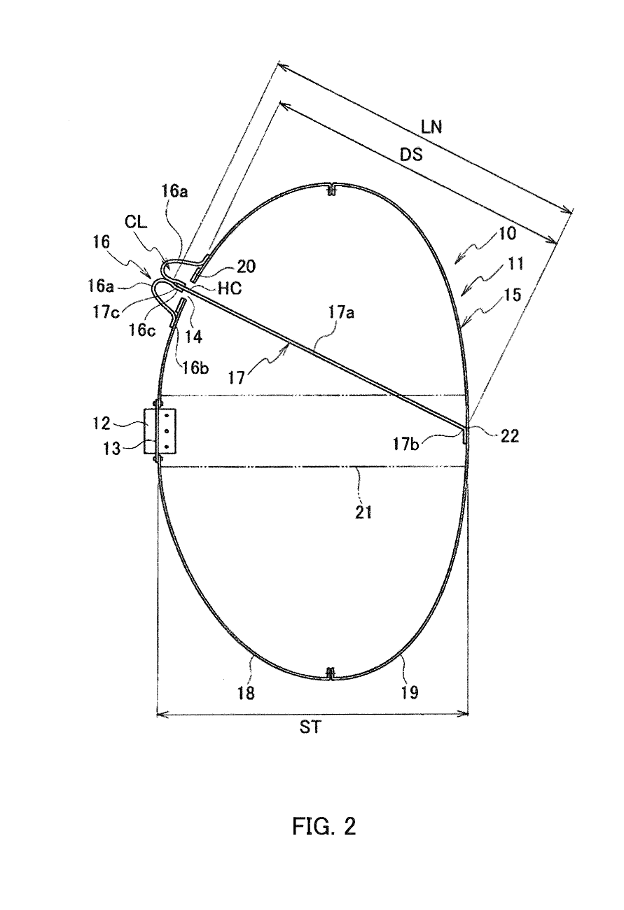

As shown in FIGS. 1 and 2, air bag apparatus 10 includes air bag 11 formed in a bag shape as a whole, inflator 12 which supplies gas to air bag 11, and retainer 13 as a retaining member for retaining air bag 11, inflator 12, and the like.

Air bag 11 includes air bag main body 15 having vent hole 14, lid body 16 which is disposed outside air bag main body 15, and connecting member 17 which connects air bag main body 15 and lid body 16 and is disposed inside air bag main body 15.

Air bag main body 15 is formed in a bag shape with a single or a plurality of base fabrics. In this embodiment, air bag main body 15 is formed of two base fabrics (base panel 18 and occupant-side panel 19). Further, air bag main body 15 has an opening portion for gas introduction, through which a gas generation section of inflator 12 is inserted. The shape of air bag main body 15, the position and shape of the opening portion for gas introduction, or the like is not particularly limited and can be appropriately set according to the specifications or the like of air bag apparatus 10.

A central portion of base panel 18 and a central portion of occupant-side panel 19 of air bag main body 15 are connected to each other by bag tether 21. Bag tether 21 is formed of a single or a plurality of base fabrics. Bag tether 21 has a function of defining bag stroke ST (refer to FIG. 2) which is the maximum deployed length with respect to a depth direction of air bag main body 15.

In this embodiment, quadrangular (rectangular) vent hole 14 is formed in base panel 18 of air bag main body 15. Vent hole 14 is also referred to as an exhaust hole. In this embodiment, vent hole 14 is formed at one position above inflator 12 in base panel 18. Further, reinforcing base fabric 20 is joined to a peripheral edge portion of vent hole 14. Reinforcing base fabric 20 is formed to have an opening substantially equal in size to vent hole 14 and joined to the peripheral edge portion of vent hole 14. The position, shape, and the like of vent hole 14 are not particularly limited and can be appropriately set according to the specifications or the like of air bag apparatus 10.

Lid body 16 is also referred to as a valve and has a function of adjusting the opening and closing of vent hole 14 in response to an inflation and deployment operation of air bag main body 15. Lid body 16 is formed of a single or a plurality of base fabrics. In this embodiment, lid body 16 is formed of two rectangular base fabrics 16a and 16a. Specifically, one end 16b of each base fabric 16a is joined to the peripheral edge portion of vent hole 14 in air bag main body 15 and other ends 16c and 16c of two base fabrics 16a and 16a are joined together, and thus lid body 16 is formed. Lid body 16 is joined to base panel 18 of air bag main body 15 so as to straddle vent hole 14. The size or shape of lid body 16 is not particularly limited and can be appropriately set according to the specifications or the like of air bag apparatus 10.

Connecting member 17 is also referred to as a valve tether and has a function of drawing lid body 16 toward the interior of air bag main body 15 in response to the inflation and deployment operation of air bag main body 15. Connecting member 17 is formed of a single or a plurality of base fabrics. In this embodiment, connecting member 17 is formed of single rectangular (string-like) base fabric 17a. Specifically, connecting member 17 has one end 17b which is joined to the central portion of occupant-side panel 19 of air bag main body 15, and other end 17c which is joined to the central portion of lid body 16 (a joining portion between other ends 16c and 16c of two base fabrics 16a and 16a). The position and shape of connecting member 17 are not particularly limited and can be appropriately set according to the specifications or the like of air bag apparatus 10.

Length LN (refer to FIG. 2) from one end 17b to other end 17c of connecting member 17 is set such that clearance CL is formed between vent hole 14 and lid body 16 when air bag main body 15 is fully inflated and deployed (at the time of bag deployment completion). For this reason, connecting member 17 has excess length portion 17e (refer to FIG. 1) which is located outside air bag main body 15 to form clearance CL between vent hole 14 and lid body 16 when air bag main body 15 is fully inflated and deployed. Specifically, length LN from one end 17b to other end 17c of connecting member 17 is longer than distance DS from joining portion 22 between connecting member 17 and air bag main body 15 to hole center HC of vent hole 14 when air bag main body 15 is fully inflated and deployed (LN>DS). Length LN of connecting member 17 is set in this manner, whereby it becomes possible to secure clearance CL between vent hole 14 and lid body 16 when air bag main body 15 is fully inflated and deployed (refer to FIG. 2).

An air bag cover (not shown) having an external appearance of a center pad of a steering wheel is mounted so as to cover air bag 11 in an inflating and deploying direction of air bag 11, whereby air bag apparatus 10 configures an air bag module.

At the time of a collision or the like of a vehicle, inflator 12 is operated by a control apparatus (not shown), and thus the gas is introduced into air bag main body 15 from inflator 12. Then, air bag main body 15 is inflated and deployed in association with to the introduction of the gas to break a tear line of the air bag cover, and protrudes from the opening of the air bag cover to the occupant side.

Hereinafter, the operational effects of this embodiment will be described.

(1) Air bag apparatus 10 according to this embodiment includes bag-shaped air bag main body 15 having vent hole 14, and lid body 16 which is disposed outside air bag main body 15. Air bag apparatus 10 further includes connecting member 17 which is disposed in the interior of air bag main body 15 and has one end 17b which is joined to air bag main body 15, and other end 17c which is joined to lid body 16. Length LN from one end 17b to other end 17c of connecting member 17 is set such that clearance CL is formed between vent hole 14 and lid body 16 when air bag main body 15 is fully inflated and deployed.

According to air bag apparatus 10 of this embodiment, since it becomes possible to secure clearance CL between vent hole 14 and lid body 16 when air bag main body 15 is fully inflated and deployed, it is possible to easily control the internal pressure of air bag main body 15 when air bag main body 15 is fully inflated and deployed. In particular, clearance CL is formed between vent hole 14 and lid body 16 when air bag main body 15 is fully inflated and deployed, whereby it becomes possible to promptly switch from the fully inflated and deployed state of air bag main body 15 to the exhaust mode for discharging the gas to the outside of air bag main body 15, after an object to be protected is protected.

(2) Length LN from one end 17b to other end 17c of connecting member 17 is longer than distance DS from joining portion 22 between connecting member 17 and air bag main body 15 to hole center HC of vent hole 14 when air bag main body 15 is fully inflated and deployed.

Length LN of connecting member 17 is set in this manner, whereby it becomes possible to secure clearance CL between vent hole 14 and lid body 16 when air bag main body 15 is fully inflated and deployed (refer to FIG. 2).

Incidentally, the air bag apparatus according to the present invention has been described with the above embodiment as an example. However, there is no limitation to this embodiment and various other embodiments can be adopted within a scope which does not depart from the gist of the present invention.

In the embodiment described above, the air bag apparatus for a driver's seat, which is provided in the steering wheel, is exemplified. However, the present invention is not limited thereto. The present invention can also be applied to, for example, an air bag apparatus for a passenger seat, which is provided in an instrument panel or the like in front of the passenger seat.

The number of vent holes for adjusting the opening and closing of the air bag main body is not limited to one (a singular number) and may be two or more (a plural number). In this case, the lid bodies may be disposed at the respective vent holes according to the position of each vent hole, or one lid body may be disposed with respect to a plurality of vent holes.

### REFERENCE SIGNS LIST

10 air bag apparatus
14 vent hole
15 air bag main body
16 lid body
17 connecting member
17b one end
17c other end
17e excess length portion
22 joining portion
CL clearance
DS distance
HC hole center
LN length

1. An air bag apparatus comprising:
a bag-shaped air bag main body having a vent hole;
a lid body which is disposed outside the air bag main body; and
a connecting member which is disposed in an interior of the air bag main body and has one end which is joined to the air bag main body, and the other end which is joined to the lid body,
wherein a length from the one end to the other end of the connecting member is set such that a clearance is formed between the vent hole and the lid body when the air bag main body is fully inflated and deployed.

2. The air bag apparatus according to claim 1, wherein the length from the one end to the other end of the connecting member is longer than a distance from a joining portion between the connecting member and the air bag main body to a hole center of the vent hole when the air bag main body is fully inflated and deployed.
